(19) United States
(12) Patent Application Publication
(10) Pub. No.: US 2025/0137314 A1
(43) Pub. Date: May 1, 2025

(54) DEVICE FOR ACTING ON A MOTOR VEHICLE ADJUSTABLE ELEMENT, SUCH AS, FOR EXAMPLE, A MOTOR VEHICLE DOOR, AND ASSOCIATED METHOD FOR OPERATING SUCH A DEVICE

(71) Applicant: KIEKERT AKTIENGESELLSCHAFT, Heiligenhaus (DE)

(72) Inventors: Alexander WEISSKE, Ratingen (DE); Ingo NÖVERMANN, Mülheim an der Ruhr (DE)

(73) Assignee: KIEKERT AKTIENGESELLSCHAFT, Heiligenhaus (DE)

(21) Appl. No.: 18/835,826

(22) PCT Filed: Jan. 13, 2023
(86) PCT No.: PCT/DE2023/100020

§ 371 Date: Aug. 5, 2024

(30) Foreign Application Priority Data
Feb. 7, 2022 (DE) 10 2022 102 779.1

(51) Int. Cl. E05F 15/79

(52) U.S. Cl. CPC E05F 15/79; E05Y 2201/218; E05Y 2400/326; E05Y 2400/33; E05Y 2900/531

(57) ABSTRACT

A device for acting on a motor vehicle adjustable element, such as, for example, a motor vehicle door. In its basic construction, the device is equipped with an arresting device and a drive device, and with a control unit which acts on one or both devices on the basis of signals from at least one sensor. According to the invention, the control unit controls the preferably currentlessly fixing arresting device and the drive device in dependence on signals from the sensor with a time overlap.

The invention relates to a device for acting on a motor vehicle adjustable element, such as a motor vehicle door, with an arresting device and a drive device, and with a control unit which acts on one or both devices in accordance with signals from at least one sensor.

This means that the control unit ensures that the arresting device, the drive device or the arresting device and the drive device are acted on, depending on the signals from the sensor. This allows different functional positions of the motor vehicle adjustable element to be realized. For example, the motor vehicle adjustable element and, in particular, the motor vehicle door can be moved back and forth or opened and closed relative to a motor vehicle body by means of the drive device. Intermediate states such as a half-open state are also conceivable. In addition, the relevant motor vehicle adjustable element or the motor vehicle door can also be fixed in any position. This is ensured by the arresting device.

In the context of the generic prior art according to EP 3 272 987 B1, a device for the externally powered and manual adjustment of such a motor vehicle adjustable element is described in detail. A drive device is provided for this purpose, with the aid of which the motor vehicle adjustable element can be adjusted by external force both in an opening direction and in an opposite closing direction.

The drive device can also be switched between a holding position and a release position. A sensor can be used to detect a desired adjustment by a user. This means that the drive device first triggers an adjustment in the direction desired by the user before the drive device is switched to its release position. This is intended to improve overall comfort during operation and when changing between the holding position and the release position of the drive device.

The door drive provided at this point changes from the holding position to its release position, for example, by interrupting a coupling between a drive motor and a drive element on the transmission side or by opening a clutch. An abrupt transition associated with this is generally intercepted within the framework of the known teaching. However, both the holding position and the release position require controlling the drive device or the known door drive. Depending on how long the motor vehicle adjustable element is in the associated functional position, this can correspond to increased power consumption.

However, the energy consumption of today's motor vehicles must be critically assessed. For this reason, the aim in practice is always to find solutions that can work with significantly reduced power consumption. This is where the invention steps in.

The invention is based on the technical problem of further developing such a device for acting on a motor vehicle adjustable element, such as a motor vehicle door, such that the required electrical energy consumption is reduced while the construction is functional at the same time.

To solve this technical problem, the invention proposes, in a generic device for acting on a motor vehicle adjustable element, that the control unit controls the preferably currentlessly fixing arresting device and the drive device in dependence on signals from the sensor with a time overlap.

In the context of the invention, first of all, two significant differences are observed compared to the prior art according to EP 3 272 987 B1. Thus, according to the invention, the arresting device preferably operates in such a manner that the motor vehicle adjustable element is regularly fixed in a currentless state by means of the arresting device. This means that if the arresting device ensures fixing or arresting the motor vehicle adjustable element, this is regularly achieved currentlessly. The transition from the fixing to the non-fixing or releasing position of the arresting device requires controlling by means of a drive motor as a component of the arresting device and therefore by acting on it with an electric current. However, during the fixing of the motor vehicle adjustable element, the arresting device is generally switched to a currentless state, such that no electrical energy is consumed at this point.

As a further difference and, as it were, a consequence of this design of the arresting device in the sense that it preferably operates in a currentless fixing manner, the invention or the control unit ensures that the arresting device and the drive device are controlled with a time overlap. This means that, in contrast to the generic teaching according to EP 3 272 987 B1, there is no switching back and forth between the arresting device and the drive device in the sense of a respective alternative.

Rather, according to the invention, functional positions are expressly observed and are provided in which, in dependence on signals from the sensor, the arresting device and the drive device are controlled overlapping in time by means of the control unit. In this case, on the one hand, the arresting device ensures that the motor vehicle adjustable element is fixed in place. On the other hand and in addition, the fixing is then carried out additionally by means of the drive device.

In this context, it has proven to be particularly advantageous if the arresting device on the one hand and the drive device on the other are designed to be technologically and functionally separate from one another. For example, an arresting device such as that described in detail in DE 10 2019 134 979 A1 of the applicant may be used as an arresting device within the scope of the invention. In contrast, a drive device such as that described in detail in DE 10 2018 120 553 A1 can be used.

In any case, the locally and functionally separate design of the arresting device on the one hand and the drive device on the other facilitates the design according to the invention, namely that the two aforementioned devices can be controlled with a time overlap by means of the control unit. In principle, however, the arresting device and the drive device can also be combined with one another. This means that a functionally separate design is not absolutely necessary and is merely a particularly suitable option.

Either way, the design according to the invention initially leads to a significant reduction in electrical energy consumption compared to the prior art. This is because, for example, during the entire time in which the motor vehicle adjustable element is fixed by means of the arresting device, the currentless fixing design of the arresting device ensures that no electrical energy is consumed unnecessarily at this point. At the same time, functionality and safety are guaranteed as with the prior art. This is because as soon as by means of the sensor an operating signal from a user is detected, for example, the control unit ensures that the arresting device and the drive device are typically controlled with a time overlap. This allows, for example, the arresting device to be transferred from its previously fixing position to the releasing position. The drive device, which is controlled simultaneously and with a time overlap in this context, then ensures that the motor vehicle adjustable element is not released in an uncontrolled manner during this process, but rather is held in its position by means of the now active drive device.

Depending on whether the motor vehicle adjustable element is subsequently to be acted on by a user with or without power assistance from the drive device, the drive device releases the motor vehicle adjustable element so that it can be moved manually by the user. Or it is also possible that the manual movement is supported by means of the drive device. These are the main advantages.

In a further advantageous embodiment, the sensor is an external force sensor which detects an external force acting on the motor vehicle adjustable element. This external force can, for example, be compared with a threshold value stored in the control unit. If this threshold value is exceeded, this is interpreted as a user signal for acting on the motor vehicle adjustable element.

In principle, however, the sensor can also be a time sensor that can be represented by means of the control unit. Alternatively or additionally, the sensor can also be designed as a displacement sensor and, for example, an opening angle sensor of the motor vehicle adjustable element. In this case, the sensor or displacement sensor is used, for example, to measure a specific opening path of the motor vehicle adjustable element in relation to a motor vehicle body. A corresponding opening angle may correspond to this.

The subject matter of the invention is also a method for operating the described device. In this case, when the motor vehicle adjustable element is open or opened in relation to the motor vehicle body and the arresting device is acted on, user interaction is detected by means of the external force sensor. Subsequently, the drive device is acted on in addition to the arresting device. This means that as soon as, with the motor vehicle adjustable element open and the arresting device acted on currentlessly, a user interaction in the form of, for example, a user request to open the door is detected by the external force sensor, the control unit ensures, in dependence on this sensor signal and according to the invention, that, in response and additionally, the drive device is acted on. This means that the arresting device and the drive device are, as described, controlled with a time overlap.

It is possible to proceed in detail in such a manner that the arresting device is released while the drive device is acted on. Subsequently, a so-called release criterion for the motor vehicle adjustable element is usually checked. This release criterion can, for example, be a time measurement by means of the time sensor. If this release criterion is not met, this results in the arresting device being acted on again.

In other words, the detected user interaction initially ensures that the drive device is acted on by means of the control unit in addition to the arresting device, so that the arresting device can then be released when the drive device is acted on at the same time. In this case, the motor vehicle adjustable element is still fixed in place by means of the drive device. The release criterion already mentioned is now checked. This may correspond to the fact that a new user interaction has taken place within a specified period of time or that the user interaction that has already taken place continues. Typically, the latter variant is the case.

This means, for example, that if a user wants to open the motor vehicle adjustable element, an opening application of force to the motor vehicle adjustable element causes the drive device to be acted on initially and simultaneously and the arresting device to be subsequently released when the currentlessly fixing arresting device is in place. If the user interaction lasts for a certain period of time, this is interpreted as a genuine request to open the door. The associated time measurement as a release criterion therefore means that the user interaction fulfills the release criterion within the time period and consequently the drive device immediately releases the vehicle adjustable element. However, it is also possible for the drive device to provide motorized support for the desired opening movement of the user.

However, if there is no new or continuous user interaction within the aforementioned time period and during the time measurement, this is interpreted as the control unit not fulfilling the release criterion. In this case, the control unit then ensures that the previously released arresting device is acted on again and holds or fixes the motor vehicle adjustable element.

This prevents the motor vehicle adjustable element from being released by a brief and possibly unintentional opening impulse, for example, and then performing uncontrolled movements. The invention effectively prevents this.

Another variant proceeds in such a manner that when the device in question is in operation and the motor vehicle adjustable element is closed and the drive device is acted on to open, the displacement sensor and/or the external force sensor is used to detect when a target position has been reached. The arresting device is then also activated and there is a time overlap between the drive device and the arresting device.

In this case, it is therefore not a matter of releasing the previously fixed motor vehicle adjustable element for an opening or closing movement. Rather, it is a matter of an opening or closing process of the motor vehicle adjustable element and subsequently fixing it by means of arresting device. For this purpose, the control unit can use the displacement sensor and/or the external force sensor to detect when the motor vehicle adjustable element has reached a target position. As soon as the target position is reached, the arresting device is activated in addition to the drive device.

However, the arresting device is typically only activated when a so-called holding criterion is met. This holding criterion may, for example, be linked to a time measurement by means of the time sensor. This means, for example, that if the motor vehicle adjustable element maintains a certain position for a predetermined period of time, which can be measured via the time sensor, this is interpreted as the target position and at the same time to the effect that the holding criterion is fulfilled. The control unit then ensures that the arresting device is activated.

Subsequently thereto and with the arresting device being activated and the holding criterion being fulfilled at the same time, the drive device can be deactivated. This means that, following this, the motor vehicle adjustable element is fixed in place solely with the aid of the arresting device which is switched to a currentless state. As the drive device has also been deactivated at this point, unnecessary power consumption is also prevented in such a case.

The motor vehicle adjustable element can reach the target position in such a manner that this corresponds to a certain completed path of the motor vehicle adjustable element, which can be detected by means of the displacement sensor or via an opening angle. However, it is also possible to determine when the target position has been reached using the external force sensor. In this case, the control unit determines that the motor vehicle adjustable element is, for example, not (or no longer) acted on by a force acting on the motor vehicle adjustable element. This may also correspond to the fact that the speed of the motor vehicle adjustable element or the force acting on it is below a threshold value for a defined time. In this case, the signal from the displacement sensor is differentiated in terms of time and the speed of the motor vehicle adjustable element is inferred therefrom. Or the time-related changes in the signal from the external force sensor are used to infer when the target position has been reached.

Either way, the procedure is such that the arresting device is only activated when the holding criterion is met. This means that the arresting device is only activated when it can be safely assumed that the motor vehicle adjustable element has reached its target position and this is also desired by the user. Subsequently, and if the holding criterion is met, the drive device is hereinafter deactivated so that it no longer contributes to power consumption.

As a result, a device for acting on a motor vehicle adjustable element as well as a method for its operation are presented, which not only works properly, but in particular can be operated with reduced electrical energy consumption. This is because the alternate acting on of the arresting device and the drive device and, in particular, the possibility of being able to control both devices with a with a time overlap, ensures that the motor vehicle adjustable element in question does not have any indifferent functional states on the one hand and can be operated and held in the desired position with a minimum of electrical energy consumption on the other. These are the main advantages.

The invention is explained in greater detail below with reference to drawings which show only one exemplary embodiment. In the drawings:

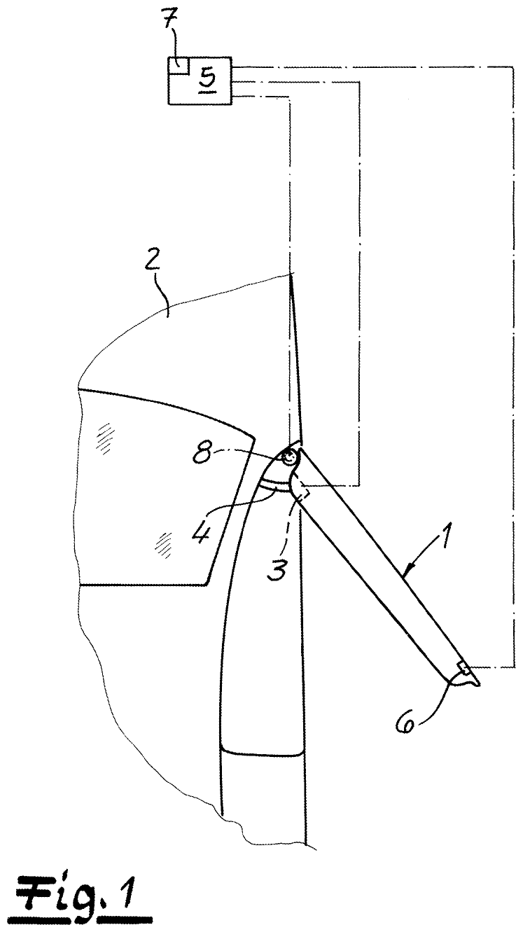

FIGS. 1 to 4 show the device according to the invention and an associated method in connection with an operation of the device for opening or closing the motor vehicle adjustable element, and

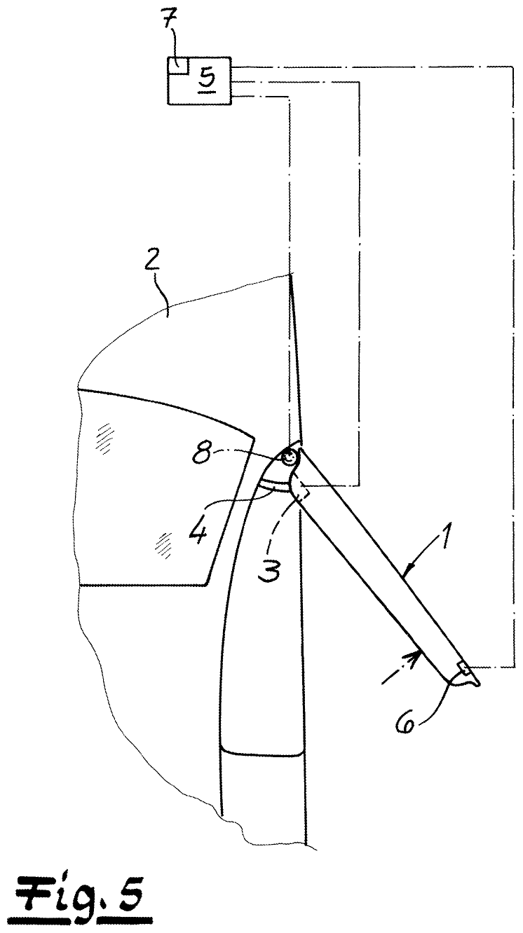

FIG. 5 shows the device according to FIGS. 1 to 4 in connection with an opening process of the motor vehicle adjustable element and its subsequent fixing by means of the arresting device.

The figures show a device for acting on a motor vehicle adjustable element 1. In the context of the representation, the motor vehicle adjustable element 1 is a motor vehicle door and, in particular, a motor vehicle side door 1 that can be rotated or pivoted relative to a motor vehicle body 2. Of course, this only applies as an example and is in no way to be understood as restrictive. This means that the motor vehicle adjustable element 1 can in principle also be a sliding door or a flap or any other adjustable element of a motor vehicle that is adjustable relative to a body 2.

The basic construction of the device includes a drive device 3 and an arresting device 4. According to the exemplary embodiment, the drive device 3 and the arresting device 4 are designed to be functionally and technologically separate from one another and can both be acted on together by means of a control unit 5. The control unit 5 is also provided and configured for evaluating signals from a sensor 6. The two devices 3,4 can be used to move and fix the motor vehicle adjustable element 1.

In addition to sensor 6, which is designed here as an external force sensor 6, a further sensor or time sensor 7 is additionally provided, which is integrated into the control unit 5 according to the exemplary embodiment and is used for time measurement. In addition, a further sensor 8 is provided in the form of a displacement sensor 8. According to the exemplary embodiment, the displacement sensor 8 is an opening angle sensor 8, by means of which an opening angle of the pivotable motor vehicle adjustable element 1 relative to the motor vehicle body 2 can be determined.

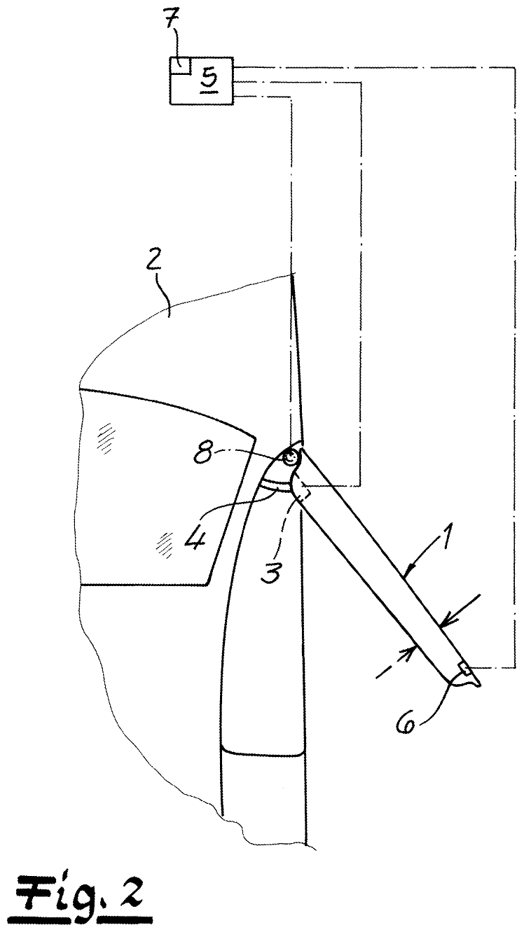

A sequence of FIGS. 1 to 4 is now used to explain a first procedure for operating the device described in principle above. Accordingly, at first a user interaction can be measured and detected when the motor vehicle adjustable element 1 is open and the arresting device 4 is acted on, namely by means of the external force sensor 6. The drive device 3 is then acted on by means of the control unit 5. Starting in FIG. 1, for this purpose the motor vehicle adjustable element or the motor vehicle door 1 is fixed by means of the arresting device 4, according to the exemplary embodiment and as already described above in a currentless manner. For this purpose, the arresting device 4 may engage behind a recess or an opening on or in the motor vehicle adjustable element 1, for example with a movable hook. If the motor vehicle door 1 arrested or fixed in this manner is now to be opened, according to the representation in FIG. 2 this corresponds to a user performing a user interaction, according to the exemplary embodiment acting on the motor vehicle adjustable element 1 with a force indicated there. The force acting on the motor vehicle adjustable element 1 causes a corresponding signal to be generated at the external force sensor 6, which can also be detected by the control unit 5.

The control unit 5 subsequently ensures that the drive device 3 is acted on in addition to the arresting device 4. In the simplest case, this can be done and designed in such a manner that an electric motor as a component of the drive device 3 is engaged in relation to the motor vehicle adjustable element 1 and in this way can work mechanically on the motor vehicle adjustable element 1. Now the arresting device 4 is released while the drive device 3 is acted on at the same time. In the exemplary case, this corresponds to the previously mentioned hook as a component of the arresting device being pivoted away from its engagement with the opening on the motor vehicle adjustable element 1.

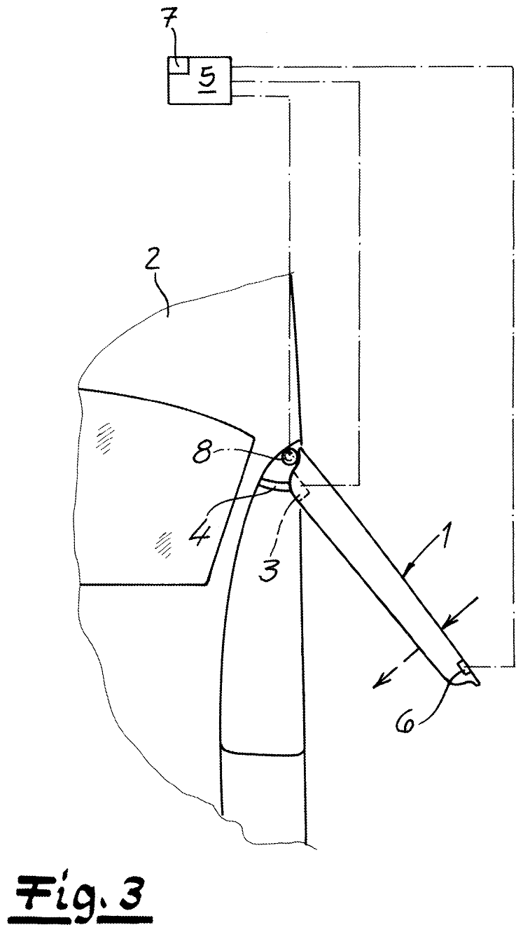

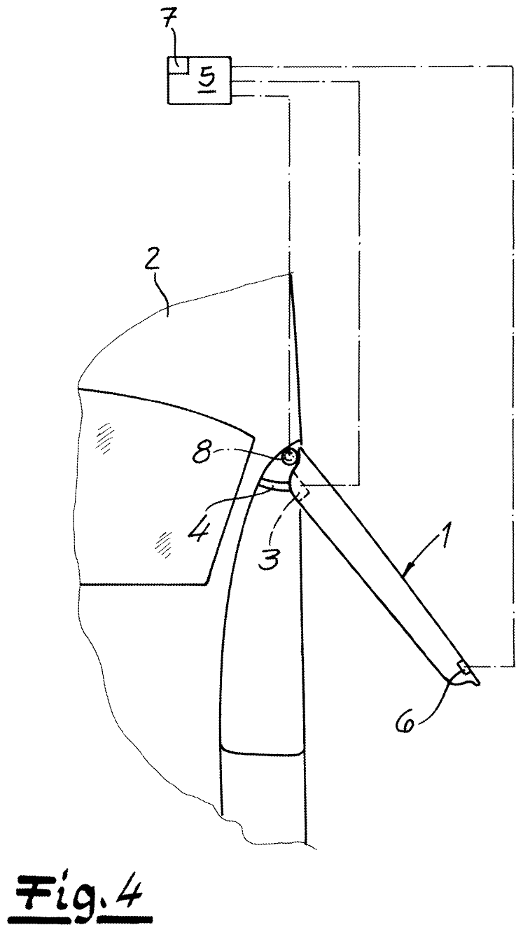

A so-called release criterion is then checked. According to the two variants in FIGS. 3 and 4, this release criterion corresponds to a time measurement that is carried out by means of time sensor 7. A specific and predefined detection period may correspond hereto. If the control unit 5 observes continued user interaction or acting on the external force sensor 6 within the detection period, this is interpreted by the control unit 5 as meaning that the release criterion has been met. As shown in the representation in FIG. 3, this means that the drive device 3 releases the motor vehicle adjustable element 1 or also that it supports the user interaction like a servomotor. This can be a closing movement or an opening movement of the motor vehicle adjustable element 1. This movement can be servo-assisted by means of drive device 3.

If the release criterion is not observed within the detection period, i.e. if there is no continued or repeated user interaction within the detection period, the initial user interaction is interpreted as a false signal. In any case, failure to meet the release criterion corresponds to the arresting device 4 being acted on again, as can be seen from FIG. 4. This results in the motor vehicle adjustable element 1 being fixed unchanged (currentlessly) by means of the arresting device 4. The drive device 3 is switched off if this has not already been done.

FIG. 5 now shows another mode of operation of the device. The point here is that when the motor vehicle adjustable element is initially closed, the drive device 3 is acted on to open the motor vehicle adjustable element. By means of the displacement sensor 8 and/or the external force sensor 6, the control unit 5 can now detect when a specific target position of the motor vehicle adjustable element 1 has been reached during this opening process. Reaching the target position can correspond to the user not (or no longer) applying a force to the motor vehicle adjustable element 1, so that in this case the force sensor 6 reports a decreasing force application signal to the control unit 5. However, it is also possible that reaching the target position is accompanied by a specific signal from the displacement sensor 6. The target position may be stored in the control unit 5 for this purpose. However, it is also conceivable that the signal from the displacement sensor 8 is differentiated with respect to time. If the speed signal determined in this manner is interpreted by the control unit as meaning that the door speed is below a threshold value for a certain time, for example, this is again interpreted as reaching the target position shown as an example in FIG. 5.

In any case, reaching the target position results overall in the arresting device 4 only being activated when an additional holding criterion is fulfilled. This holding criterion is linked to a time measurement by means of the time sensor 7. If the speed of the motor vehicle adjustable element 1 is below the threshold value or has dropped to zero within the time period specified by the time sensor 7, or if a force is no longer applied within the time period, this is interpreted by the control unit 5 as a fulfilled holding criterion. This then leads to the arresting device 4 being activated by means of the control unit 5. At the same time, the fulfilled holding criterion ensures that the drive device 3 can subsequently be deactivated and is also deactivated in order to overall reduce the electrical energy consumption.

### LIST OF REFERENCE SIGNS

Motor vehicle adjustable element 1
Motor vehicle side door 1
Body 2
Drive device 3
Arresting device 4
Control unit 5
Sensor/External force sensor 6
Force sensor 6
Time sensor 7
Sensor/Displacement sensor 8
Opening angle sensor 8

1. A device for acting on a motor vehicle adjustable element, the device comprising:
an arresting device and a drive device, and at least one sensor, and with a control unit which acts on the arresting device and the drive device on the basis of signals from the at least one sensor,
wherein the control unit controls the arresting device and the drive device in dependence on signals from the at least one sensor with a time overlap of acting on both the arresting device and the drive device at a same time.

2. The device according to claim 1, wherein the at least one sensor includes an external force sensor which detects an external force acting on the motor vehicle adjustable element.

3. The device according to claim 1, wherein the at least one sensor includes a time sensor.

4. The device according to claim 1, wherein the at least one sensor includes a displacement sensor that detects displacement of the motor vehicle adjustable element.

5. A method for operating a device according to claim 1, wherein the at least one sensor includes an external force sensor, the method comprising the steps of:
when the motor vehicle adjustable element is open and the arresting device is acted on, detecting a user interaction by the external force sensor detecting an external force on the motor vehicle adjustable element, and
additionally acting on the drive device when the control unit determines that the external force exceeds a threshold.

6. The method according to claim 5, further comprising releasing the arresting device while the drive device is acted on at the same time, and checking a release criterion.

7. The method according to claim 6, wherein the at least one sensor includes a time sensor, and the release criterion is coupled to a time measurement by the time sensor, and
when the release criterion is not fulfilled, the arresting device is acted on again.

8. A method for operating a device according to claim 1, wherein the at least one sensor includes a displacement sensor and/or an external force sensor, the method comprising the steps of:
when the motor vehicle adjustable element is closed and the drive device is acted on for opening, detecting the reaching of a target position by the motor vehicle adjustable element by the displacement sensor and/or the external force sensor, and
then additionally activating the arresting device when the target position is reached.

9. The method according to claim 8, wherein the at least one sensor further includes a time sensor, and the arresting device is only activated when a holding criterion is met, which is linked to a time measurement by the time sensor in that the holding criterion is satisfied when the motor vehicle adjustable element maintains a certain position for a predetermined period of time.

10. The method according to claim 9, wherein when the arresting device is activated and the holding criterion is met, the drive device is deactivated.

11. The device according to claim 1, wherein the arresting device is configured such that during fixing the motor vehicle adjustable element by the arresting device, the arresting device is currentless in that no electrical energy is consumed by the arresting device.

12. The device according to claim 1, wherein the arresting device and the drive device are separately positioned from each other.

13. The device according to claim 1, wherein the arresting device includes a moveable hook that engages with the motor vehicle adjustable element.

14. The device according to claim 4, wherein the displacement sensor is an open angle sensor that measures an angle of displacement of the motor vehicle adjustable element.

15. The method according to claim 5, wherein the arresting device is configured such that during fixing the motor vehicle adjustable element by the arresting device, the arresting device is currentless in that no electrical energy is consumed by the arresting device.

16. The method according to claim 7, wherein the release criterion comprises detecting the user interaction for a predetermined period of time.

17. The method according to claim 8, wherein the arresting device is configured such that during fixing the motor vehicle adjustable element by the arresting device, the arresting device is currentless in that no electrical energy is consumed by the arresting device.

18. The method according to claim 8, wherein reaching the target position is detected by the external force sensor based on a decreasing external force acting on the motor vehicle adjustable element.

19. The method according to claim 8, wherein reaching the target position is detected by the displacement sensor detecting that the motor vehicle adjustable element is moving at a speed below a threshold value for a defined period of time.
